(19) United States
(12) Patent Application Publication
(10) Pub. No.: US 2022/0342446 A1
(43) Pub. Date: Oct. 27, 2022

(54) RECONFIGURABLE APPARATUS WITH ELECTRONIC DISPLAYS

(71) Applicant: OSOM Products, Inc., Palo Alto, CA (US)

(72) Inventors: Jason Sean Gagne-Keats, Cupertino, CA (US); David John Evans, V, Portola Valley, CA (US)

(21) Appl. No.: 17/661,011

(22) Filed: Apr. 27, 2022

Related U.S. Application Data
(60) Provisional application No. 63/180,560, filed on Apr. 27, 2021.

(51) Int. Cl. G06F 1/16; G06F 3/14; G06F 3/04886

(52) U.S. Cl. CPC G06F 1/1647; G06F 3/1446; G06F 3/04886; G06F 1/1681; G06F 1/1686

(57) ABSTRACT

The embodiments disclosed herein describe reconfigurable apparatuses with electronic displays. A reconfigurable laptop can unfold from a laptop into a desktop monitor. The reconfigurable laptop can feature two displays, one in each clamshell, instead of one display and one traditional keyboard. In place of a keyboard are a display, as well as touch sensitive sensors and haptic devices for typing feedback. This allows a user to use the reconfigurable laptop similarly to a traditional laptop. However, when the user desires, the reconfigurable laptop can be opened flat, creating a single screen double the size of a standard laptop screen. The reconfigurable laptop can be paired with a wired or wireless keyboard and mouse to create a larger device similar to a desktop.

### CROSS-REFERENCE TO RELATED APPLICATION

This application claims the benefit of U.S. Provisional Patent Application No. 63/180,560, filed Apr. 27, 2021, which is incorporated by reference in its entirety herein.

### TECHNICAL FIELD

The present disclosure is generally related to computers having electronic displays.

### BACKGROUND

Computer tablets, on which users type on and view a single screen have gained in popularity. However, tablets can run out of memory space because they do not have the storage capacity of laptops. This can require a user to go through all their apps and uninstall those they don't need. Further, sweat and other natural oils in a user's skin can leave marks on the single display. Tablets also have a shorter lifespan, as compared to laptops. Tablets can require constant repair. Tablet batteries can be slow charging, short duration, or sometimes have charging failures. Further, when a tablet is plugged into a PC or laptop, it can require installing a new driver, causing additional user effort.

### BRIEF DESCRIPTION OF THE DRAWINGS

FIG. 1 is a drawing illustrating an example reconfigurable apparatus with electronic displays in a first configuration, in accordance with one or more embodiments.

FIG. 2 is a drawing illustrating an example reconfigurable apparatus with electronic displays in a second configuration, in accordance with one or more embodiments.

FIG. 3 is a drawing illustrating an example reconfigurable apparatus with electronic displays in a third configuration, in accordance with one or more embodiments.

FIG. 4 is a block diagram illustrating an example computer system, in accordance with one or more embodiments.

### DETAILED DESCRIPTION

Embodiments of the present disclosure will be described more thoroughly from now on with reference to the accompanying drawings. Like numerals represent like elements throughout the several figures, and in which example embodiments are shown. However, embodiments of the claims can be embodied in many different forms and should not be construed as limited to the embodiments set forth herein. The examples set forth herein are non-limiting examples and are merely examples, among other possible examples. Throughout this specification, plural instances (e.g., “610”) can implement components, operations, or structures (e.g., “610a”) described as a single instance. Further, plural instances (e.g., “610”) refer collectively to a set of components, operations, or structures (e.g., “610a”) described as a single instance. The description of a single component (e.g., “610a”) applies equally to a like-numbered component (e.g., “610b”) unless indicated otherwise. These and other aspects, features, and implementations can be expressed as methods, apparatuses, systems, components, program products, means or steps for performing a function, and in other ways. These and other aspects, features, and implementations will become apparent from the following descriptions, including the claims.

A laptop, or notebook computer, is a portable personal computer. A laptop is typically “clamshell,” having an electronic display on the inside of an upper clamshell and a keyboard on the inside of a lower clamshell. The lower clamshell will often include a touchpad used to manipulate a cursor on the laptop's display. A laptop includes many of the same features as a desktop computer, such as a processor, memory, and operating system. Modern laptops have increasing processing power, graphics, and functionality, such as touchscreens and biometric readers. This increased performance is available even as laptops become smaller and more portable. However, even with these advances, the clamshell form-factor with display and physical keyboard has largely remained unchanged.

The embodiments disclosed herein describe reconfigurable apparatuses with electronic displays. The disclosed embodiments relate to a structure that can be used as a reconfigurable laptop. Embodiments of the invention include a laptop that can unfold from a laptop into a desktop monitor. The reconfigurable laptop can feature two displays, one in each clamshell, instead of one display and one traditional keyboard. In place of a keyboard are a display, as well as touch sensitive sensors and haptic devices for typing feedback. This allows a user to use the reconfigurable laptop similarly to a traditional laptop. However, when the user desires, the reconfigurable laptop can be opened flat, creating a single screen double the size of a standard laptop screen. The reconfigurable laptop can be paired with a wired or wireless keyboard and mouse to create a larger device similar to a desktop.

In embodiments, a reconfigurable apparatus includes a first housing made of plastic or rubber and configured to house a first electronic display. A second housing made of plastic or rubber is configured to house a second electronic display communicably coupled to the first electronic display, wherein at least the second electronic display is a touchscreen displaying a virtual keyboard. A hinge made of plastic or metal is configured to pivotally attach the first housing to the second housing and position the first housing at an angle with respect to the second housing to enable a user to type on the virtual keyboard and view results of the typing on the first electronic display. A webcam disposed on the first housing is configured to capture video to be streamed in a video call by a computer disposed in either the first housing or the second housing.

In embodiments, one of the first housing or the second housing contains a computer processor, a memory, and a battery to power the computer processor, the memory, the first electronic display, and the second electronic display.

In embodiments, each of the first housing and the second housing contains at least one of a computer processor, a memory, or a battery to power the computer processor, the memory, the first electronic display, and the second electronic display.

In embodiments, the first electronic display is a touchscreen.

In embodiments, the apparatus includes at least one of an accelerometer or a gyroscope configured to detect one of the first electronic display or the second electronic display that is positioned horizontally. The computer is configured to display the virtual keyboard on the one of the first electronic display or the second electronic display that is positioned horizontally, such that the user can type on the virtual keyboard.

In embodiments, an apparatus includes a first housing configured to house a first electronic display. A second housing is configured to house a second electronic display. A computer is disposed in either the first housing or the second housing, and communicably coupled to the first electronic display and the second electronic display. A hinge is configured to pivotally attach the first housing to the second housing. The hinge positions the first housing substantially coplanar with respect to the second housing to enable the first electronic display and the second electronic display to be used as monitors for the computer.

In embodiments, a webcam is disposed on one of the first housing or the second housing and configured to capture video to be streamed in a video call by a computer disposed in either the first housing or the second housing.

In embodiments, at least one of the first electronic display or the second electronic display is a touchscreen.

In embodiments, the first electronic display has a shape and a size, and the second electronic display has the shape and the size.

In embodiments, the first electronic display and the second electronic display have a same aspect ratio and a same display resolution.

In embodiments, the first electronic display has a first display resolution, and the second electronic display has a second display resolution different from the first display resolution.

In embodiments, one of the first electronic display or the second electronic display extends onto another of the first electronic display or the second electronic display.

In embodiments, the apparatus includes a stand attached to at least one of the first housing, the second housing, or the hinge. The stand is configured to position the apparatus substantially vertical with respect to a surface that the apparatus is placed on.

In embodiments, the computer is configured to receive wireless signals from a wireless keyboard and mouse. The computer displays input from the wireless keyboard and mouse based on the wireless signals on at least one of the first electronic display or the second electronic display.

In embodiments, a magnet is embedded in the second housing and configured to generate a magnetic field. A sensor is disposed in the first housing and configured to detect a strength of the magnetic field based on a distance between the sensor and the magnet. The strength of the magnetic field increases as an angle between the first electronic display and the second electronic display decreases.

In embodiments, an apparatus includes a first housing configured to house a first electronic display. A second housing is configured to house a second electronic display. A hinge is configured to pivotally attach the first housing to the second housing. The hinge positions the first housing parallel to the second housing, such that a surface of the first housing contacts a surface of the second housing, and the first electronic display faces a first direction and the second electronic display faces a second direction opposite to the first direction.

In embodiments, the apparatus includes a stand attached to at least one of the first housing, the second housing, or the hinge. The stand is configured to position the apparatus, such that the first electronic display faces a user viewing the first electronic display, and the second electronic display faces a surface that the apparatus is placed on.

In embodiments, the apparatus includes a computer disposed in either the first housing or the second housing, and communicably coupled to at least the first electronic display. A webcam is disposed on the first housing and configured to capture video to be streamed in a video call.

In embodiments, the apparatus includes a computer disposed in either the first housing or the second housing, and communicably coupled to the first electronic display and the second electronic display. At least one of an accelerometer or a gyroscope is embedded in one of the first housing or the second housing. The at least one of an accelerometer or a gyroscope is configured to detect one of the first electronic display or the second electronic display that is facing away from a surface that the apparatus is placed on. The at least one of an accelerometer or a gyroscope causes the computer to display content on only the one of the first electronic display or the second electronic display that is facing away from a surface.

The advantages and benefits of the apparatuses disclosed herein include the ability to add a second screen for giving presentations to groups, view two programs open full screen at once, enhance a portable gaming system, and touch up designs with a stylus. Further, the apparatuses disclosed can include an entire suite of office and entertainment features packed into a light portable touchscreen monitor and include a true LED backlight. The apparatuses are plug & play and require no special set up. The apparatus is more powerful than tablets yet has more portable functionality than traditional laptops. As a tablet, the apparatus 200 offers the same innovative touch screen capabilities users of those devices have come to love. As a laptop, the apparatus 200 provides the processing power, keyboard and other features of a more advanced PC.

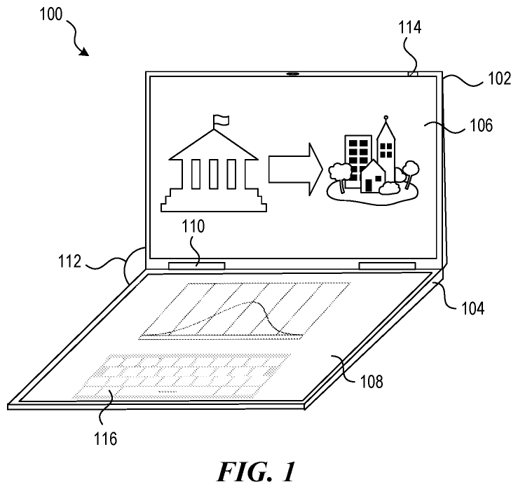

FIG. 1 is a drawing illustrating an example reconfigurable apparatus 100 with electronic displays 106, 108 in a first configuration, in accordance with one or more embodiments. In embodiments, the reconfigurable apparatus 100 includes a first housing 102 made of plastic or rubber and configured to house a first electronic display 106. A second housing 104 is made of plastic or rubber and configured to house a second electronic display 108 that is communicably coupled to the first electronic display 106, wherein at least the second electronic display 108 is a touchscreen displaying a virtual keyboard 116.

For example, the apparatus 100 can include a first housing 102 and a second housing 104. Each housing refers to the material or casing that helps protect or connect the components (e.g., electronic displays 106, 108). For example, first housing 102 protects the edges and rear of the electronic display 102. Each housing can be made of rubber, plastic, or a combination thereof. Likewise, embodiments of the example reconfigurable apparatus 100 can include different and/or additional components or can be connected in different ways.

In embodiments, a hinge 110 made of plastic or metal is configured to pivotally attach the first housing 102 to the second housing 104. The hinge 110 can position the first housing 102 at an angle 112 with respect to the second housing 104 to enable a user to type on the virtual keyboard 116 and view results of the typing on the first electronic display 106. For example, the first housing 102 and the second housing 104 can be folded together to close or shut the apparatus 100. In the first configuration shown by FIG. 1, the first housing 102 and second housing 104 are attached at approximately a 90-degree angle (angle 112). The first housing 102 and the second housing 104 can be connected by hinge 110. Neither the first housing 102 nor the second housing 104 include a physical keyboard.

In embodiments, one of the first housing 102 or the second housing 104 contains a computer processor, a memory, and a battery to power the computer processor, the memory, the first electronic display, and the second electronic display. For example, the second housing 104 can include a processor, a battery, memory, and other hardware components. In embodiments, each of the first housing 102 and the second housing 104 contains at least one of a computer processor, a memory, or a battery to power the computer processor, the memory, the first electronic display, and the second electronic display. For example, these components can be in the first housing 102 or divided between the first and second housings 102, 104.

The first housing 102 can include a first display 106, and the second housing 104 can include a second display 108. The first display 106 and the second display 108 can be the same size or different sizes. In embodiments, the first electronic display 106 is a touchscreen. For example, the first display 106 and/or the second display 108 can be touchscreens, such as capacitive, resistive, etc. The second display 108 can be a touchscreen, and a user can type on the second display using an on-screen keyboard, similar to using a laptop with a physical keyboard. In embodiments, the first display 106 can be a touchscreen, allowing the user to select elements on the first display without manipulating a cursor.

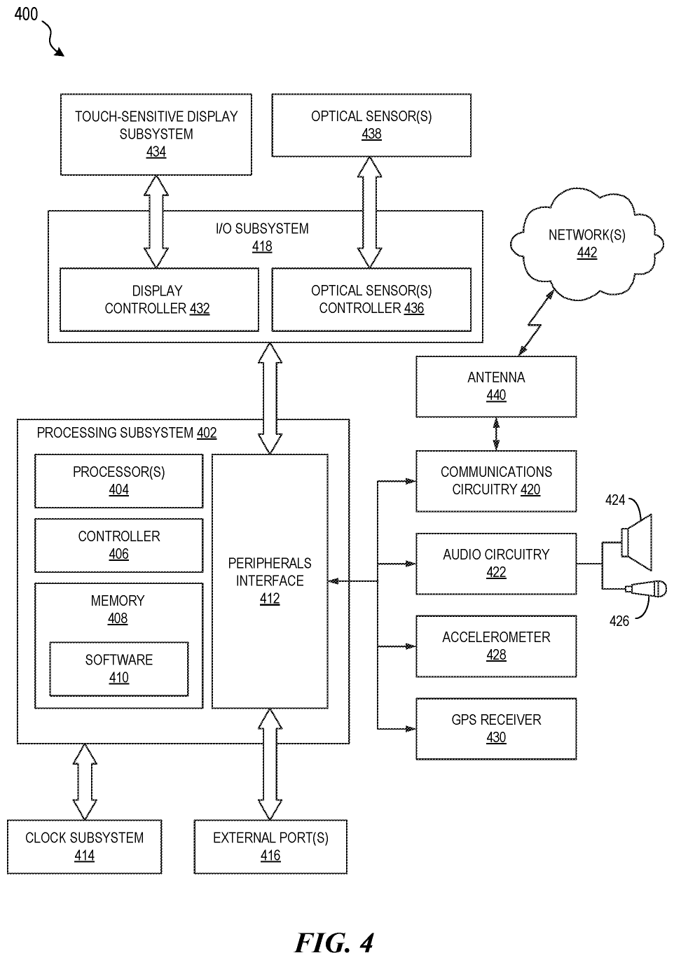

In embodiments, both displays are touchscreens, and the user can use either display as a keyboard. In embodiments, the apparatus 100 includes at least one of an accelerometer or a gyroscope configured to detect which of the first electronic display 106 or the second electronic display 108 is positioned horizontally. The accelerometer is a tool that measures proper acceleration, i.e., the rate of change of velocity of a body in its own instantaneous rest frame. This is different from coordinate acceleration, which is acceleration in a fixed coordinate system. The accelerometer is used in the apparatus 100 so that images on the electronic displays 106, 108 are always displayed upright. The gyroscope is a device used for measuring or maintaining orientation and angular velocity. The gyroscope can be a microchip-packaged MEMS gyroscope (sometimes called gyrometer), a solid-state ring laser, a fiber optic gyroscope, or a quantum gyroscope. For example, the computer is configured to display the virtual keyboard 116 on the one of the first electronic display 106 or the second electronic display 108 that is positioned horizontally, such that the user can type on the virtual keyboard 116. The computer is implemented using components of the example computer system illustrated and described in more detail with reference to FIG. 4. For example, the apparatus 100 can include an accelerometer or gyroscope and detect whether the first display 106 or the second display 108 is horizontal and display an on-screen keyboard 116 on that display. Alternatively, or additionally, the user can manually choose to show or hide a keyboard on either display via a user interface.

In embodiments, the apparatus 100 includes a webcam disposed on the first housing 102. The webcam is configured to capture video to be streamed in a video call by the computer. A webcam is a video camera integrated into the first housing 102 that feeds or streams an image or video (e.g., of a user facing the first electronic display 106) in real time to or through a computer network, such as the Internet. The webcam can be used during a video chat session involving two or more people, with conversations that include live audio and video. Webcam software operating on the computer enables users to record a video or stream the video on the Internet. As video streaming over the Internet requires much bandwidth, such streams usually use compressed formats. The maximum resolution of a webcam is also lower than most handheld video cameras, as higher resolutions would be reduced during transmission. The lower resolution enables webcams to be relatively inexpensive compared to most video cameras, but the effect is adequate for video chat sessions.

In embodiments, a magnet is embedded in the second housing 104 and configured to generate a magnetic field. A sensor 114 is disposed in the first housing 102 and configured to detect a strength of the magnetic field based on a distance between the sensor 114 and the magnet. The strength of the magnetic field increases as an angle between the first electronic display 106 and the second electronic display 108 decreases. For example, the apparatus 100 can include a sensor 114 that detects the relative angle between the first and second housing 102 and 104 and adjusts the first and second display 106 and 108 accordingly. For example, if the apparatus 100 detects that the angle between the first and second housing 102 and 104 is close to 90 degrees, then the apparatus 100 can be configured to display an on-screen keyboard 116 on one of the displays 102 or 104, as described in FIG. 1.

In embodiments, the sensor 114 is a Hall effect sensor. A Hall effect sensor (or simply Hall sensor) is a type of sensor which detects the presence and magnitude of a magnetic field (e.g., generated by the magnet embedded in the housing 104) using the Hall effect. The output voltage of a Hall sensor is directly proportional to the strength of the field and reflects how close the magnet is to the sensor 114. In embodiments, the magnet is a permanent magnet and the sensor 114 is a leaf sensor. The magnet can be a neodymium magnet. Advantageously, neodymium magnets have a smaller size. In embodiments, the sensor 114 is a reed switch operated by the applied magnetic field by the magnet. The sensor 114 can include a pair of ferromagnetic flexible metal contacts in a hermetically sealed glass envelope. The contacts are normally open, closing when a magnetic field is present, or they may be normally closed and open when a magnetic field is applied. The sensor 114 may be actuated by an electromagnetic coil in the housing 104, making a relay, or by bringing the magnet near it. When the magnetic field is removed, the contacts in the sensor 114 return to their original position.

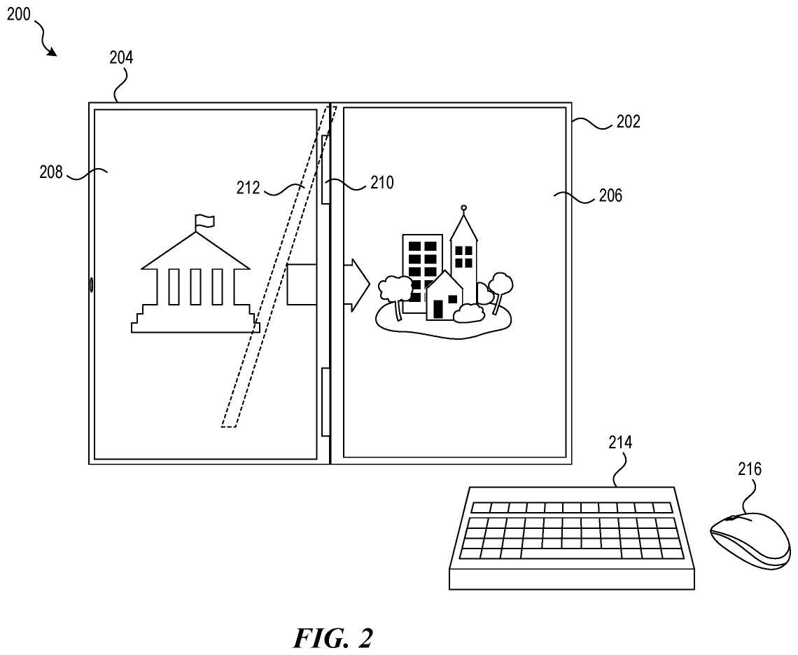

FIG. 2 is a drawing illustrating an example reconfigurable apparatus 200 with electronic displays 206, 208 in a second configuration, in accordance with one or more embodiments. The apparatus 200 includes a first housing 202 configured to house a first electronic display 206. A second housing 204 is configured to house a second electronic display 208. The first electronic display 206 has a shape and a size. For example, the shape can be rectangular, square, widescreen, etc. The second electronic display 208 has the same shape, such that the two displays overlay each other when the apparatus 200 is shut. Likewise, embodiments of the example reconfigurable apparatus 200 can include different and/or additional components or can be connected in different ways.

The aspect ratio of the first electronic display 206 (the proportional relationship between the width and the height of the display) is one of 5:4, 4:3, 16:10, or 16:9. The second electronic display 208 has a matching aspect ratio. The size of each electronic display 206, 208 can range from 15″ up to 34″. A preferable screen size is 22″. A larger screen size offers more versatility, larger viewing angles, more built-in features, and greater choice of connection ports. In embodiments, the first electronic display and the second electronic display have a same aspect ratio and a same display resolution. The resolution refers to the number of distinct pixels in each dimension that can be displayed. The higher the resolution the sharper the picture quality. A preferable resolution is 1920x1080 as it offers a good balance between space and picture quality. The resolution of either electronic display 206, 208 can be 720p (1280 x 720 — HD or HD Ready), 1080p (1920 x 1080 — FHD or Full HD), 1440p (2560 x 1440— QHD or Quad HD), 2160p (3840 x 2160 — 4K, UHD or Ultra HD), or 4320p (7680 x 4320 — 8K). In embodiments, the first electronic display has a first display resolution, and the second electronic display has a second display resolution different from the first display resolution.

A computer is disposed in either the first housing 204 or the second housing 204, and communicably coupled to the first electronic display 206 and the second electronic display 208. A hinge 210 is configured to pivotally attach the first housing 202 to the second housing 204. In the second configuration, the hinge 210 positions the first housing 202 substantially coplanar with respect to the second housing 204 to enable the first electronic display 206 and the second electronic display 208 to be used as monitors for the computer.

For example, in the second configuration, the first housing 202 and second housing 204 are substantially coplanar, (e.g., angled with respect to each other in a range of 170-190 degrees, and preferably 180 degrees). The second configuration allows a user to use both displays 206 and 208 as monitors. A user can convert the apparatus 200 from the first configuration (see FIG. 1) to the second configuration (see FIG. 2) by opening the apparatus 200 along the hinge 210.

In embodiments, one of the first electronic display 206 or the second electronic display 208 extends onto another of the first electronic display 206 or the second electronic display 208. For example, in the second configuration shown by FIG. 2, the first electronic display 206 can extend into the second electronic display 208, or the two displays can be separate or mirrored. In embodiments, the apparatus 200 includes a stand 212 attached to at least one of the first housing 202, the second housing 204, or the hinge 210. The stand 212 is configured to position the apparatus 200 substantially vertical with respect to a surface (e.g., table, desk, tray) that the apparatus 200 is placed on. For example, the first housing 202 or second housing 204 can include a kickstand or other support element so that the first and second displays 208, 208 are positioned substantially vertically. The term substantially vertical means that the electronic displays are angled to a table or other support surface beneath in a range of 80-110 degrees.

In embodiments, the computer is configured to receive wireless signals from a wireless keyboard 214 and mouse 216. The computer displays input from the wireless keyboard 214 and mouse 216 based on the wireless signals on at least one of the first electronic display 206 or the second electronic display 208. For example, the apparatus 200 can support an external keyboard 214 and mouse 216, so the user does not need to use either of the displays 206 or 208 as a keyboard in this configuration. In embodiments, the laptop 100 can support additional accessories, such as a stylus or stand 212. In embodiments, the apparatus 200 includes a webcam disposed on one of the first housing 202 or the second housing 204. The webcam is configured to capture video to be streamed in a video call by a computer disposed in either the first housing 202 or the second housing 206.

A user can reconfigure the apparatus 200 between the first configuration (shown by FIG. 1) and the second configuration shown by FIG. 2 in a variety of situations. For example, a user could use the apparatus 200 in the first configuration when traveling and use the second configuration at a home or office desk with an external keyboard 214 and mouse 216. In another example, the user could use the first configuration to type a document and use the second configuration to draw an image. The apparatus 200 has both laptop and tablet functionality. For example, the apparatus 200 has a touch screen and other tablet-style conveniences. In embodiments, the apparatus 200 also has a PC operating system, keyboard, and other features of a laptop. The apparatus 200 is more powerful than tablets yet has more portable functionality than traditional laptops. As a tablet, the apparatus 200 offers the same innovative touch screen capabilities users of those devices have come to love. As a laptop, the apparatus 200 provides the processing power, keyboard and other features of a more advanced PC. In embodiments, the keyboard 214 and displays 206, 208 remain connected at all times, even as the touchscreens flip around or otherwise convert for tablet use. In embodiments, a touch screen portion is unplugged and used independently as a standalone tablet.

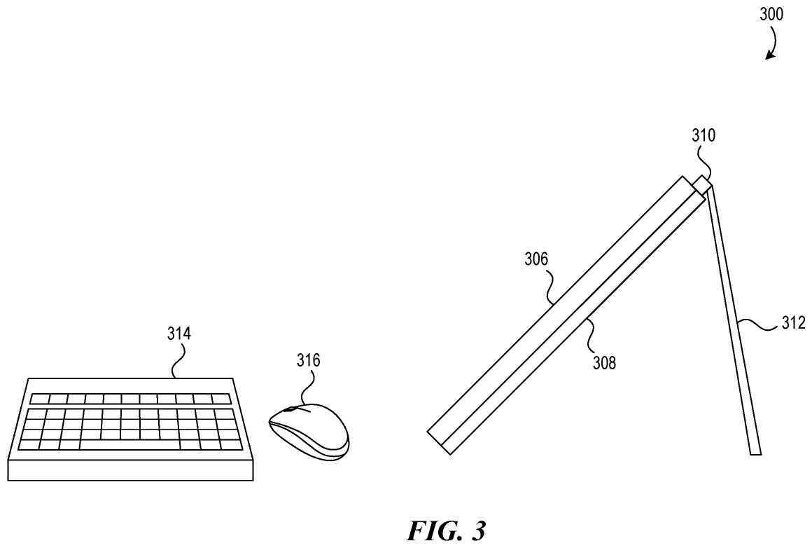

FIG. 3 is a drawing illustrating an example reconfigurable apparatus 300 with electronic displays 306, 308 in a third configuration, in accordance with one or more embodiments. In embodiments, the apparatus 300 can have additional configurations. In embodiments, the apparatus 300 includes a first housing configured to house a first electronic display 306. A second housing is configured to house a second electronic display 308. A hinge 310 is configured to pivotally attach the first housing to the second housing. The hinge 310 positions the first housing parallel to the second housing, such that a surface of the first housing contacts a surface of the second housing, and the first electronic display 306 faces a first direction and the second electronic display 308 faces a second direction opposite to the first direction.

For example, the apparatus 300 is shown by FIG. 3 fully opened so that the first display 306 and the second display 308 are facing opposite each other, i.e., the angle between the first and second housing is about 360 degrees. In this configuration, a user can use either display 306 similarly to a tablet. The apparatus 300 can also be closed so the first and second displays 106 and 108 are facing each other, similar to how a traditional laptop is closed.

In embodiments, the apparatus 300 includes a stand 312 attached to at least one of the first housing, the second housing, or the hinge 310. The stand 312 is configured to position the apparatus 300, such that the first electronic display 306 faces a user viewing the first electronic display 306, and the second electronic display 308 faces a surface that the apparatus 300 is placed on. In embodiments, the apparatus 300 includes a computer disposed in either the first housing or the second housing, and communicably coupled to the first electronic display 306 and the second electronic display 308. At least one of an accelerometer or a gyroscope is embedded in one of the first housing or the second housing. The at least one of an accelerometer or a gyroscope is configured to detect one of the first electronic display 306 or the second electronic display 308 that is facing away from a surface that the apparatus 300 is placed on. For example, in FIG. 3, the one of the first electronic display 306 or the second electronic display 308 that is facing away from a surface that the apparatus 300 is placed on is the first electronic display 306. The at least one of an accelerometer or a gyroscope causes the computer to display content on only the one of the first electronic display 306 or the second electronic display 308 that is facing away from the surface. The apparatus 300 thus functions like a tablet in the third configuration.

In embodiments, the apparatus 300 has USB Type-C connectivity—with its ability to transfer power, data, and video over a single cable. In such embodiments, the apparatus 300 does not need a dedicated AC adapter and can have just a single USB-C port that handles all the connectivity. In embodiments, the apparatus 300 has HDMI or other connectors. The apparatus 300 can have a stand 312.

In embodiments, the apparatus 300 has a stand 312 that is a thin but stiff plastic board, with several grooves or creases on which it folds. At one end is a magnetic strip, which adheres to the back of a housing at its top. Folding the sheet in the middle, with the angle pointing away from the user, props up the apparatus 300. The bottom of a housing inserts into a groove, securing it and tilting the device upward. In embodiments, the stand 312 is a rigid, flat base, containing the ports, to which the displays 306, 306 are attached via hinges. The displays 306, 308 can be set to any selected angle simply by tilting it. In embodiments, the apparatus 300 can be pivoted by hand. The embedded computer can automatically correct the image so it is always right side up, whether the display is in landscape or portrait mode.

In embodiments, each of the displays 306, 308 have a luminance of around 180 nits (also expressed as “candelas per meter squared”), though they can have a luminance of between 230 and 300 nits. In embodiments, the displays 306, 308 have in-plane switching (IPS) technology, vertical-alignment (VA), or twisted-nematic (TN) panels. The displays 306, 308 can use traditional power adapters. A display 306 can draw power through an adapter, while two cables connect to the computer. One is HDMI, to handle transfer of the image displayed on the display 306, and the other is USB (through a USB-A port), to record pen motions a user makes when drawing on the interactive display. HDMI (usually in the form of mini-HDMI) can also be used.

FIG. 4 is a block diagram illustrating an example computer system 400, in accordance with one or more embodiments. Components of the example computer system 400 can be used to implement the reconfigurable apparatuses with electronic displays disclosed herein, laptops, desktop monitors, touch sensitive sensors, haptic devices, a wired or wireless keyboard and mouse, and the like. Likewise, embodiments of the system 400 can include different and/or additional components or can be connected in different ways. The computer system 400 can include generic components and/or components specifically designed to carry out the disclosed technology. The computer system 400 may be a standalone device or part of a distributed system that spans networks, locations, machines, or combinations thereof. For example, components of the computer system 400 may be included in or coupled to a system-on-chip (SOC), a single-board computer (SBC) system, a desktop or laptop computer, a kiosk, a mainframe, a mesh of computer systems, or combinations thereof.

In embodiments, the computer system 400 can operate as a server device or a client device in a client-server network environment, or as a peer machine in a peer-to-peer system. In embodiments, the computer system 400 may perform one or more steps of the disclosed embodiments in real-time, near real-time, offline, by batch processing, or combinations thereof.

The computer system 400 includes a processing subsystem 402 that includes one or more processors 404 (e.g., Central Processing Units (CPUs), Application Specific Integrated Circuits (ASICs), and/or Field Programmable Gate Arrays (FPGAs)), a memory controller 406, memory 408 that can store software 410, and a peripherals interface 412. The memory 408 may include volatile memory (e.g., random-access memory (RAM)) and/or non-volatile memory (e.g., read-only memory (ROM)). The memory 408 can be local, remote, or distributed. The computer system 400 can also include a clock subsystem 414 that controls a timer for use In embodiments. The components of the computer system 400 are interconnected over a bus (not shown) operable to transfer data between hardware components.

The peripherals interface 412 is coupled to one or more external ports 416, which can connect to an external power source, for example. The peripherals interface 412 is also coupled to an I/O subsystem 418. Other components coupled to the peripherals interface 412 include communications circuitry 420, audio circuitry 422 for a speaker 424 and a microphone 426, an accelerometer 428, a GPS receiver 430 (or Global Navigation Satellite System (GLONASS) or other global navigation system receiver), and other sensors (not shown). The GPS receiver 430 is operable to receive signals concerning the geographic location of the computer system 400. The accelerometer 428 can be operable to obtain information concerning the orientation (e.g., portrait or landscape) of computer system 400.

The I/O subsystem 418 includes a display controller 432 operative to control a touch-sensitive display system 434, which further includes the touch-sensitive display of the computer system 400. The I/O subsystem 418 also includes an optical sensor(s) controller 436 for one or more optical sensors 438 of the computer system 400. The I/O subsystem 48 includes other components (not shown) to control physical buttons such as “home” button.

The communications circuitry 420 can configure the antenna 440 of the computer system 400. In embodiments, the antenna 440 is structurally integrated with the computer system 400 (e.g., embedded in the housing 110 or display screen) or coupled to the computer system 400 through the external ports 416. The communications circuitry 420 can convert electrical signals to/from electromagnetic signals that are communicated by the antenna 440 to networks 442 or other devices. For example, the communications circuitry 420 can include radio frequency (RF) circuitry that processes RF signals communicated by the antenna 440.

The communications circuitry 420 can include circuitry for performing well- known functions such as an RF transceiver, one or more amplifiers, a tuner, oscillators, a digital signal processor, a CODEC chipset, a subscriber identity module (SIM card or eSIM), and so forth. The communications circuitry 420 may communicate wirelessly via the antenna elements 440 with the networks 442 (e.g., the Internet, an intranet and/or a wireless network, such as a cellular network, a wireless local area network (LAN) and/or a metropolitan area network (MAN)) or other devices.

The software 410 can include an operating system (OS) software program, application software programs, and/or modules such as a communications module, a GPS module, and the like. For example, the GPS module can estimate the location of the computer system 400 based on the GPS signals received by the GPS receiver 430. The GPS module can provide this information to components of the computer system 400 for use in various applications (e.g., to provide location-based access to service providers).

A software program, when referred to as “implemented in a computer-readable storage medium,” includes computer-readable instructions stored in the memory (e.g., memory 408). A processor (e.g., processor 404) is “configured to execute a software program” when at least one value associated with the software program is stored in a register that is readable by the processor. In embodiments, routines executed to implement the disclosed embodiments may be implemented as part of OS software (e.g., MICROSOFT WINDOWS and LINUX) or a specific software application, component, program, object, module, or sequence of instructions referred to as “computer programs.”

Computer programs typically comprise one or more instructions set at various times in various memory devices of a computing device (e.g., computer system 400), which, when read and executed by at least one processor (e.g., processor 404), will cause the computer system 400 to execute functions involving the disclosed embodiments. In embodiments, a carrier containing the aforementioned computer program product is provided. The carrier is one of an electronic signal, an optical signal, a radio signal, or a non-transitory computer-readable storage medium (e.g., the memory 408).

Operation of a memory device (e.g., memory 408), such as a change in state from a binary one (1) to a binary zero (0) (or vice versa) may comprise a visually perceptible physical change or transformation. The transformation may comprise a physical transformation of an article to a different state or thing. For example, a change in state may involve accumulation and storage of charge or a release of stored charge. Likewise, a change of state may comprise a physical change or transformation in magnetic orientation or a physical change or transformation in molecular structure, such as a change from crystalline to amorphous or vice versa.

The computer system 400 can be any type of electronic device that can communicate wirelessly with a network node and/or with another handheld device in a cellular, computer, and/or mobile communications system. Examples of a handheld device include smartphones (e.g., APPLE IPHONE, SAMSUNG GALAXY, NOKIA LUMINA), tablet computers (e.g., APPLE IPAD, SAMSUNG NOTE, AMAZON FIRE, MICROSOFT SURFACE), wireless devices capable of machine-to-machine (M2M) communication, wearable electronic devices, and any other handheld device that is capable of accessing the networks 442.

The computer system 400 may store and transmit (e.g., internally and/or with other electronic devices over a network) code (composed of software instructions) and data using machine-readable media, such as non-transitory machine-readable media (e.g., machine-readable storage media such as magnetic disks, optical disks, read only memory (ROM), flash memory devices, and phase change memory) and transitory machine-readable transmission media (e.g., electrical, optical, acoustical, or other forms of propagated signals, such as carrier waves or infrared signals).

The computer system 400 can include hardware such as one or more processors coupled to one or more other components, such as non-transitory machine- readable media to store code and/or data, user input/output (I/O) devices (e.g., a keyboard, a touchscreen, and/or a display), and network connections (e.g., an antenna) to transmit code and/or data using propagating signals. The coupling of the processor(s) and other components is typically through one or more busses and bridges (also referred to as bus controllers). Thus, a non-transitory machine-readable medium of a given electronic device typically stores instructions for execution on processor(s) of that electronic device. One or more parts of an embodiment of the present disclosure may be implemented using different combinations of software, firmware, and/or hardware.

The networks 442 may include any combination of private, public, wired, or wireless systems such as a cellular telephone network, a computer network, the Internet, and the like. Any data communicated over the network(s) 442 may be encrypted or unencrypted at various locations or along different portions of the networks. Examples of wireless systems include Wideband Code Division Multiple Access (WCDMA), High Speed Packet Access (HSPA), WiMax, Wi-Fi, Wireless Local Area Network (WLAN), and Global System for Mobile Communications (GSM), GSM Enhanced Data Rates for Global Evolution (EDGE) Radio Access Network (GERAN), and other systems that may also benefit from exploiting the scope of this disclosure.

The computer system 400 may use a variety of communications standards, protocols, number of frequency bands, frequencies, and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), 3rd Generation Partnership Project (3GPP) related standards, BLUETOOTH, Wireless Fidelity (Wi-Fi) (e.g., IEEE 802.11a, 802.11b, 802.11g, 802.11n, 802.11ad, 802.11ay), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed.

Aspects of the disclosed embodiments may be described in terms of algorithms and symbolic representations of operations on data bits stored in memory. These algorithmic descriptions and symbolic representations generally include a sequence of operations leading to a desired result. The operations require physical manipulations of physical quantities. Usually, though not necessarily, these quantities take the form of electric or magnetic signals that are capable of being stored, transferred, combined, compared, and otherwise manipulated. Customarily, and for convenience, these signals are referred to as bits, values, elements, symbols, characters, terms, numbers, or the like. These and similar terms are associated with physical quantities and are merely convenient labels applied to these quantities.

The computer system 400 may include other components that are not shown nor further discussed herein for the sake of brevity. One having ordinary skill in the art will understand any hardware and software that is included but not shown in FIG. 4. While embodiments have been described in the context of fully functioning handheld devices, those skilled in the art will appreciate that the various embodiments are capable of being distributed as a program product in a variety of forms and that the disclosure applies equally, regardless of the particular type of machine or computer-readable media used to actually effect the embodiments.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc.

The description and drawings herein are illustrative and are not to be construed as limiting. Numerous specific details are described to provide a thorough understanding of the disclosure. However, in certain instances, well-known details are not described in order to avoid obscuring the description. Further, various modifications can be made without deviating from the scope of the embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms can be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of “storage” and that the terms can on occasion be used interchangeably.

Consequently, alternative language and synonyms can be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification.

It is to be understood that the embodiments and variations shown and described herein are merely illustrative of the principles of this invention and that various modifications can be implemented by those skilled in the art.

We claim:

1. A reconfigurable apparatus comprising:
a first housing made of plastic or rubber and configured to:
house a first electronic display having a shape and a size;
a second housing made of plastic or rubber and configured to:
house a second electronic display having the shape and the size, wherein at least the second electronic display is a touchscreen configured to display a virtual keyboard;
a hinge made of plastic or metal and configured to:
pivotally attach the first housing to the second housing; and
position the first housing at an angle with respect to the second housing to enable a user to type on the virtual keyboard and view results of the typing on the first electronic display;
a computer disposed in either the first housing or the second housing, and communicably coupled to the first electronic display and the second electronic display; and
a webcam disposed on the first housing and configured to:
capture video to be streamed in a video call by the computer.

2. The apparatus of claim 1, wherein one of the first housing or the second housing contains a computer processor, a memory, and a battery to power the computer processor, the memory, the first electronic display, and the second electronic display.

3. The apparatus of claim 1, wherein each of the first housing and the second housing contains at least one of a computer processor, a memory, or a battery to power the computer processor, the memory, the first electronic display, and the second electronic display.

4. The apparatus of claim 1, wherein the first electronic display is a touchscreen.

5. The apparatus of claim 1, comprising at least one of an accelerometer or a gyroscope configured to detect one of the first electronic display or the second electronic display that is positioned horizontally,
wherein the computer is configured to display the virtual keyboard on the one of the first electronic display or the second electronic display that is positioned horizontally, such that the user can type on the virtual keyboard.

6. The apparatus of claim 1, comprising:
a magnet embedded in the second housing and configured to generate a magnetic field; and
a sensor disposed in the first housing and configured to detect a strength of the magnetic field based on a distance between the sensor and the magnet, wherein the strength of the magnetic field increases as an angle between the first electronic display and the second electronic display decreases.

7. An apparatus comprising:
a first housing configured to house a first electronic display;
a second housing configured to house a second electronic display;
a computer disposed in either the first housing or the second housing, and communicably coupled to the first electronic display and the second electronic display; and
a hinge configured to:
pivotally attach the first housing to the second housing; and
position the first housing substantially coplanar with respect to the second housing to enable the first electronic display and the second electronic display to be used as monitors for the computer.

8. The apparatus of claim 7, comprising:
a webcam disposed on one of the first housing or the second housing, and configured to:
capture video to be streamed in a video call by a computer disposed in either the first housing or the second housing.

9. The apparatus of claim 7, wherein at least one of the first electronic display or the second electronic display is a touchscreen.

10. The apparatus of claim 7, wherein the first electronic display has a shape and a size, and the second electronic display has the shape and the size.

11. The apparatus of claim 7, wherein the first electronic display and the second electronic display have a same aspect ratio and a same display resolution.

12. The apparatus of claim 7, wherein the first electronic display has a first display resolution and the second electronic display has a second display resolution different from the first display resolution.

13. The apparatus of claim 7, wherein one of the first electronic display or the second electronic display extends onto another of the first electronic display or the second electronic display.

14. The apparatus of claim 7, comprising a stand attached to at least one of the first housing, the second housing, or the hinge,
the stand configured to position the apparatus substantially vertical with respect to a surface that the apparatus is placed on.

15. The apparatus of claim 7, wherein the computer is configured to:
receive wireless signals from a wireless keyboard and mouse; and
display input from the wireless keyboard and mouse based on the wireless signals on at least one of the first electronic display or the second electronic display.

16. The apparatus of claim 7, comprising:
a magnet embedded in the second housing and configured to generate a magnetic field; and
a sensor disposed in the first housing and configured to detect a strength of the magnetic field based on a distance between the sensor and the magnet, wherein the strength of the magnetic field increases as an angle between the first electronic display and the second electronic display decreases.

17. An apparatus comprising:
a first housing configured to house a first electronic display;
a second housing configured to house a second electronic display; and
a hinge configured to:
pivotally attach the first housing to the second housing; and
position the first housing parallel to the second housing,
such that a surface of the first housing contacts a surface of the second housing, and
the first electronic display faces a first direction and the second electronic display faces a second direction opposite to the first direction.

18. The apparatus of claim 17, comprising a stand attached to at least one of the first housing, the second housing, or the hinge,
the stand configured to position the apparatus,
such that the first electronic display faces a user viewing the first electronic display, and
the second electronic display faces a surface that the apparatus is placed on.

19. The apparatus of claim 17, comprising:
a computer disposed in either the first housing or the second housing, and communicably coupled to at least the first electronic display; and
a webcam disposed on the first housing and configured to:
capture video to be streamed in a video call.

20. The apparatus of claim 17, comprising:
a computer disposed in either the first housing or the second housing, and communicably coupled to the first electronic display and the second electronic display; and
at least one of an accelerometer or a gyroscope embedded in one of the first housing or the second housing, and configured to:
detect one of the first electronic display or the second electronic display that is facing away from a surface that the apparatus is placed on;
cause the computer to display content on only the one of the first electronic display or the second electronic display that is facing away from the surface.
